(19) United States
(12) Patent Application Publication
(10) Pub. No.: US 2012/0075047 A1
(43) Pub. Date: Mar. 29, 2012

(54) TRANSFORMER CORE

(75) Inventors: Michael LUCKEY, Marsberg (DE); Wolfgang Mönig, Brilon (DE); Benjamin Weber, Winterberg (DE)

(73) Assignee: ABB Technology AG, Zurich (CH)

(21) Appl. No.: 13/296,679

(22) Filed: Nov. 15, 2011

Related U.S. Application Data
(63) Continuation of application No. PCT/EP2010/002592, filed on Apr. 28, 2010.

(30) Foreign Application Priority Data
May 16, 2009 (EP) 09006635.8

(51) Int. Cl. H01F 27/08

(52) U.S. Cl. 336/60

(57) ABSTRACT

A transformer core for a power transformer, and a power transformer including such a transformer core are provided. The transformer core includes at least two transformer core laminations which are arranged in parallel and are at least approximately congruently adjacent to each other. The transformer core laminations have a similar outline. At least one through-hole is arranged in the outline in each case. The transformer core laminations are comprised of at least predominantly an amorphous ferromagnetic material. At least one cooling channel is arranged between the transformer core laminations.

### RELATED APPLICATION

This application claims priority as a continuation application under 35 U.S.C. §120 to PCT/EP 2010/002592, which was filed as an International Application on Apr. 28, 2010 designating the U.S., and which claims priority to European Application 09006635.8 filed in Europe on May 16, 2009. The entire contents of these applications are hereby incorporated by reference in their entireties.

### FIELD

The present disclosure relates to a transformer core for a power transformer, and to a power transformer with such a transformer core.

### BACKGROUND INFORMATION

It is known that transformers serve to transmit power in an energy supply by means of adapting the voltage from a first voltage level to a second level. Instead of power transformers with an oil filling, which have been used in the past to a large extent, power transformers in a dry construction, so-called dry transformers, are being used increasingly more.

In this case, the construction of a power transformer in a dry construction is very similar to that of the power transformer with an oil filling. For instance, in the case of a power transformer in a dry construction, similar to power transformers with an oil filling, the respective winding bodies are applied on cores made of ferromagnetic material which in each case are attached at both ends to yokes and form a magnetic circuit.

In the case of power transformers with an oil filling, heat loss is absorbed by the oil and is given off through suitable cooling surfaces or separate coolers. However, in the case of dry transformers, heat loss is removed by means of air convection. The lower specific heating capacity of air with respect to oil simply means a power limitation for dry transformers.

In the windings of a loaded transformer, there are ohmic losses due to the currents of the windings and due to eddy currents in the conductive material. These ohmic losses are superimposed by no-load losses and, where appropriate, short-circuit losses as well as hysteresis losses.

No-load losses are mainly determined by the induction and the nature of the core, and are approximately independent of the transformer operating temperature. The short-circuit losses are temperature-dependent and increase at a constant charge with the temperature or the specific resistance of the conductor material. In order to keep hysteresis losses as low as possible, core materials with a very narrow hysteresis loop may be used.

To reduce the heat losses of a dry transformer resulting from this and to thus improve its load capacity, amorphous core material has recently been used, instead of grain-oriented core material.

However, the use of amorphous materials requires new constructions and processing modes because, on the one hand, large core cross-sections are required due to the smaller flow density as compared with a conventional transformer core, and, on the other hand, an amorphous core material is more sensitive to higher temperatures than in the case of a grain-oriented core sheet.

Furthermore, amorphous material, which is available mostly as a flat ribbon material, is mechanically very sensitive, so the widths of the ribbon material that can be provided are also limited, for example, to 200 mm. Therefore, the mechanically realizable design sizes of a transformer core are also limited. Thus, the achievable rated powers of transformers with a core of amorphous material have since been limited, for example, to 1 MVA, whereas dry transformers with a conventional core have power values of up to 20 MVA and higher.

### SUMMARY

An exemplary embodiment of the present disclosure provides a transformer core for a power transformer. The exemplary transformer core includes at least two transformer core laminations arranged in parallel and at least almost congruently adjacent to one another. The transformer core laminations have a similar outline. The exemplary transformer core also includes at least one through-hole provided in the outline in each case, and at least one cooling channel arranged between the transformer core laminations. The transformer core laminations are at least predominantly comprised of an amorphous ferromagnetic material.

An exemplary embodiment of the present disclosure provides a power transformer including the above-described transformer core and at least one winding.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a three-dimensional view of a transformer core lamination according to an exemplary embodiment of the present disclosure;

FIG. 2 shows a plan view of a transformer core lamination with spacing elements according to an exemplary embodiment of the present disclosure;

FIG. 3 shows a side view of a transformer core according to an exemplary embodiment of the present disclosure; and

FIG. 4 shows a cutaway view of a transformer core limb with electric winding according to an exemplary embodiment of the present disclosure.

### DETAILED DESCRIPTION

Exemplary embodiments of the present disclosure provide a transformer core of amorphous material which increases the so far achievable rated powers of a power transformer with an amorphous core. Exemplary embodiments of the present disclosure also provide a corresponding power transformer.

Exemplary embodiments of the present disclosure provide a transformer core having at least two transformer core laminations arranged in parallel and at least almost congruently adjacent to one another having an at least similar outline, where at least one through-hole is provided in the outline in each case. The transformer core laminations are at least predominantly made up of an amorphous ferromagnetic material, and at least one cooling channel is arranged between the transformer core laminations.

The at least one through-hole serves as a winding window for one or several transformer windings that are to be arranged subsequently. In accordance with an exemplary embodiment, a transformer core lamination extends in this case substantially perpendicular to its outline to a specific height. The height is limited by the constructive size that can be mechanically reached and amounts to, for example, from 15 cm to 25 cm or also above. In the case of too large transformer core sizes, the self weight of the core could already lead to a risk of breaking due to the mechanical sensitivity of the amorphous ferromagnetic core material. Furthermore, the problem of core heating during the operation of the power transformer becomes more and more critical with increasing height or thickness of the transformer core lamination.

Similar outlines in this case do not necessarily mean identical outlines. Instead, it is also possible, for example, in the case of the arrangement of three transformer core laminations, to provide the two outer laminations with a somewhat larger through-hole and a somewhat smaller outer outline than the central lamination.

Due to the modular distribution of the transformer core in several transformer core laminations, each core lamination has to be manufactured separately and forms an at least mechanically stabilized unit after manufacture, which can be transported and assembled as such with additional components to result in a larger transformer core.

An arrangement of several such transformer core laminations with cooling channels located therebetween increases the cooling surface for the transformer core thus assembled, such that intense excessive heating of the temperature-sensitive core material can also be counteracted.

The combination of a modular arrangement of transformer core laminations with cooling channels located therebetween thus advantageously enables the design and operation of transformer core made of an amorphous ferromagnetic material significantly increased in size.

In accordance with an exemplary embodiment of the present disclosure, multiple cooling channels extend along the entire outline. The available cooling surface is hereby used to a large extent and a correspondingly high cooling effect is thus enabled. Both natural cooling, such as a passage of ambient air through the cooling channels reaching the cooling channels through lower inlet holes and in heated state leaving through upper outlet holes, for example, and also forced cooling are possible.

According to an exemplary embodiment of the present disclosure, the amorphous ferromagnetic material is expressed in the form of a ribbon and is arranged in several adjacent layers running transverse to the outline around the at least one through-hole, such that a thickness of a transformer core lamination results from a width of the ribbon material.

An amorphous core material expressed in the form of ribbon can well be transported on rollers despite its mechanical sensitivity and furthermore enables a flexible manufacturing process for a transformer core or a transformer core lamination. In accordance with an exemplary embodiment, the ribbon material can be placed in ring-like layers around the at least one through-hole. One layer includes an angle of 360°, for example, whereby a sheet exactly surrounds the at least one through-hole. An adjacent layer is then formed by an additional sheet.

360° angled-layers are particularly advantageous as, in the case of a suspended assembly of a transformer core or a transformer core lamination, the mechanically sensitive sheet, which has a thickness of 15-50 μm for example, can be suspended on the upper edge of the core to be manufactured or on a fastening device. On each side, respectively, the sheet then hangs downwards due to the force of gravity and then it can be joined together at the lower edge of the transformer core to be manufactured at its two ends, preventing a mechanical load to the greatest possible extent.

In accordance with an exemplary embodiment, if there are several through-holes or winding windows, a sheet surrounds in the outer layers in each case several or all the through-holes to thus assure greater mechanical stability of the manufactured transformer core.

In accordance with an exemplary embodiment of the transformer core according to the present disclosure, the outline of the at least two transformer core laminations is approximately rectangular in each case, and so is the at least one through-hole, respectively, such that at least two transformer core limbs and at least two transformer core yokes are formed. The term rectangular is to interpreted such that in each case the bending radii due to the ribbon material are taken into account, for example 100 mm-300 mm and greater, such that as a general rule sharp edges are not formed.

This form corresponds approximately to the form of a conventional transformer core and allows a simplified arrangement of windings on the transformer limbs thus formed. An exemplary embodiment of the transformer core includes in this case two rectangular through-holes or winding windows, so that three limbs are formed which allow using the transformer core for a three-phase power transformer.

In accordance with an exemplary embodiment of the transformer core according to the present disclosure, at least two transformer core laminations can be opened and closed by at least one limb and/or yoke, respectively, such that in the open state a cylindrical hollow body can be slid over at least one limb, where such body is then penetrated by the limb.

A possibility for such a layered opening includes, for example, the transformer core being arranged perpendicularly in suspension and the sheets forming the transformer core or the transformer core laminations being joined together, respectively, in the part then located below. After opening, the respective sheets, which previously formed the lower yoke, hang downwards as a prolongation of the respective transformer limbs and a cylindrical hollow body, for example, a winding, can be slid on from below.

In accordance with an exemplary embodiment, the at least one cooling channel is formed at least in part by spacing elements separating the transformer core laminations. Such a kind of a cooling channel prevents an additional thermal resistance between the cooling medium, for example air, and the adjacent transformer core laminations.

In accordance with an exemplary embodiment, the at least one cooling channel is formed at least in part by at least one hollow element. This is advantageous in case a cooling medium such as a liquid is used. In this case, the surface of the core is protected against direct contact with the cooling medium and a closed cooling circuit can be formed.

In accordance with an exemplary embodiment of the transformer core according to the present disclosure, the at least one cooling channel is made up at least for the most part of an electrically insulating material, for example, a resin-impregnated hard fiber material.

In accordance with an exemplary embodiment of the present disclosure, a common supply connection and/or a common discharge connection is provided for a cooling medium flowing through the at least one cooling channel, which is advantageous particularly in the case of forced cooling with a liquid cooling medium.

In accordance with an exemplary embodiment of the present disclosure, the transformer core is, in operation, arranged in a hanging way with an outline oriented substantially perpendicularly. The mechanical loads for the transformer core are thus additionally reduced.

According to an exemplary embodiment of the transformer core according to the present disclosure, at least one electric winding arranged around a winding axis is arranged on a limb of the transformer core. The winding is penetrated along its winding axis by the limb. This corresponds to a winding arrangement in conventional transformer cores.

Exemplary embodiments of the present disclosure also provide a power transformer with a transformer core of the type described above. In accordance with an exemplary embodiment, this is a three-phase transformer with at least three primary and three secondary windings in each case. The advantages of the transformer core according to the disclosure described above can also be applied in a corresponding manner to such a transformer.

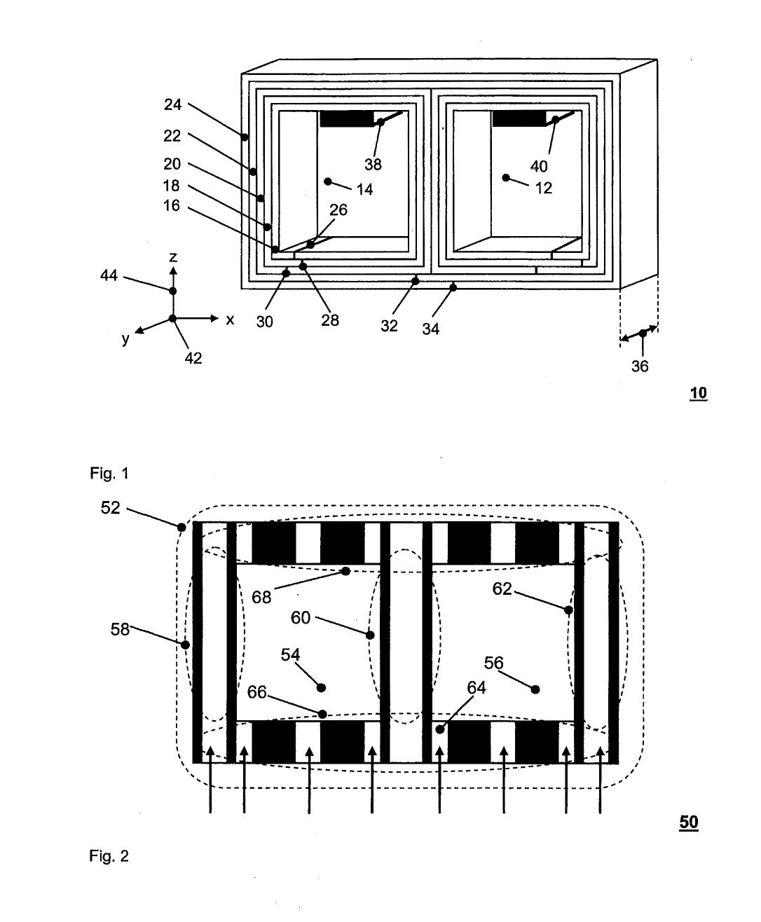

FIG. 1 shows a three-dimensional view of a transformer core lamination 10 according to an exemplary embodiment of the present disclosure. The orientation of the three-dimensional coordinates are indicated through the coordinate system 42. The transformer core lamination 10 has a rectangular outline in orientation z 44 as well as two rectangular through-holes 12, 14 perpendicular to the outline in direction y, serving as a winding window. The transformer core lamination 10 is formed by multiple layers 16, 18, 20, 22, 24 of an amorphous ferromagnetic ribbon material. The actual number of layers, due to the reduced thickness of approximately 15-50 μm, are much greater than the five layers indicated in the example of FIG. 1. For example, there may be several thousand layers. It must be observed in the exemplary depiction of FIG. 1 that since a minimum bending radius of the sheets must be maintained, the edges of the outline are not formed angularly as indicated in the drawing. Instead, the edges of the outline are formed, for example, with a radius of 100 mm-300 mm.

Each layer is formed in the exemplary embodiment of FIG. 1 by exactly one revolving sheet with a width designated by reference number 36, the two ends of which in the depiction are joined in the lower yoke area of the transformer core lamination. The transformer core lamination can be re-opened just in these areas, which are indicated in FIG. 1 as opening areas 26, 28, 30, 32, 34, if needed, for example for sliding, in an additional production step, a winding from below onto the then accessible transformer core lamination limbs.

The three inner layers of ribbon material 16, 18, 20 as indicated in FIG. 1 respectively surround one of the two through-holes or winding windows 12, 14, respectively. The two outer layers 22, 24 as indicated in FIG. 1 surround both through-holes 12, 14 with the inner layers 16, 18, 20, respectively. This is particularly useful for reasons of mechanical stability of the transformer core lamination 10, which is depicted in suspension on the two suspension devices 38, 40. The suspended arrangement is advantageous particularly in manufacture, but also later on in operation, because the mechanical load for the transformer core or the transformer core lamination 10 is thus reduced.

FIG. 2 shows a transformer core lamination 52 with spacing elements in a plan view 50 according to an exemplary embodiment of the present disclosure. The outline of the transformer core lamination 52 is also rectangular in the example of FIG. 2 and has two through-holes 54, 56, rectangular as well, serving as winding windows. Three transformer core limbs 58, 60, 62 are thus formed which are connected at their two ends by a yoke 66, 68, respectively.

Spacing elements, which are shaped rectangularly and drawn as black rectangles in the example of FIG. 2, are indicated as being arranged at the second transformer core lamination 52. As an outcome of this, cooling channels are formed between these spacing elements, the height of which corresponds to the approximately uniform height of the spacing elements. In an actual arrangement, the respective transformer core is arranged vertically, such that, with natural cooling, a flow of air from bottom to top takes place through the cooling channels, as indicated by the arrows. One of the arrows is indicated with reference number 64 by way of example.

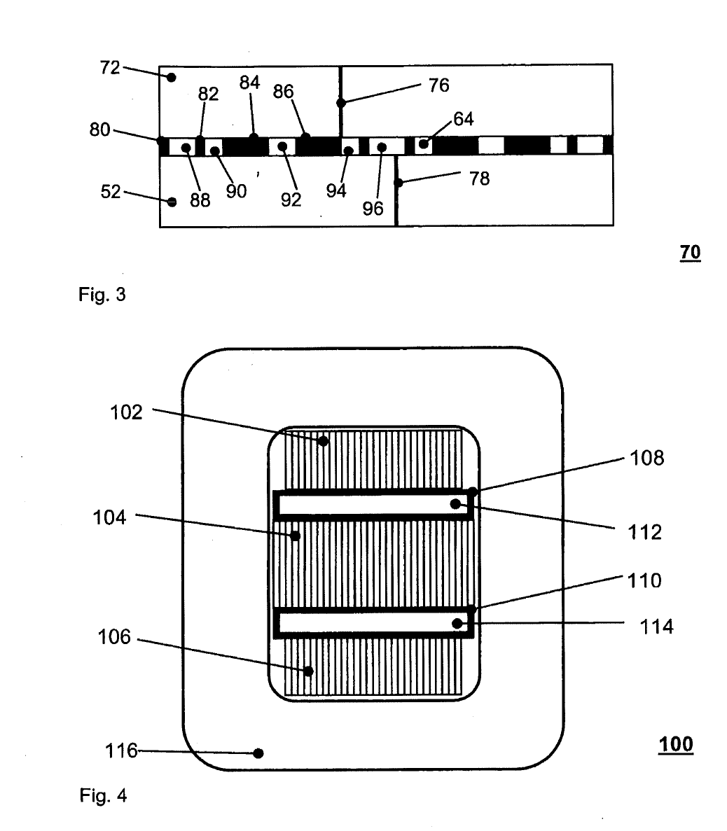

FIG. 3 shows a side view of a transformer core 70 in accordance with an exemplary embodiment of the present disclosure. The transformer core 70 is formed by the second transformer core lamination 52 already shown in FIG. 2 with the corresponding spacing elements as well as by a third transformer core lamination 72 having an identical construction. The cooling channels 88, 90, 92, 94, 96 and the first cooling channel 64 already indicated in FIG. 2 are visible in this cutaway view and have a reference number. The cooling channels are formed between spacing elements 80, 82, 84, 86 and the other spacing elements not indicated. The opening areas 76 and 78 of the two transformer core laminations, at which the revolving outer sheets are joined, can also be seen.

Such assembly of the sheets forming the transformer core or the transformer core lamination is possible, for example, by means of a layered gearing and by wrapping of the limbs or yokes formed with a suitable ribbon fixing material.

FIG. 4 shows a transformer core limb with electric winding in a cutaway view 100 according to an exemplary embodiment of the present disclosure. The transformer core limb is formed by three transformer core lamination limbs 102, 104, 106 as well as the hollow elements 108 and 110 arranged therebetween, the inner area of which forms the cooling channels 112 and 114. Such hollow elements are particularly useful when using a cooling medium other than ambient air, because in this case a closed circuit of the cooling medium can be formed. The width and the height of the transformer core laminations limb cross-sections are selected such that a cross-section of the transformer core limb similar to an ellipse is obtained, corresponding to the hollow cylindrical inner cross-section of the winding 116. Furthermore, the cooling effect is homogenized throughout the cross-section of the limb because the outer transformer core laminations 102, 106 adjacent only on one side to a cooling channel 112 or 114 are thinner than the central transformer core lamination 104 surrounded on both sides by cooling channels 112, 114.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE NUMBERS

10 first transformer core lamination by way of example
12 first through-hole
14 second through-hole
16 first layer of ribbon material
18 second layer of ribbon material
20 third layer of ribbon material
22 fourth layer of ribbon material
24 fifth layer of ribbon material
26 first opening area
28 second opening area
30 third opening area
32 fourth opening area
34 fifth opening area
36 width of ribbon material
38 first suspension device
40 second suspension device
42 coordinate system
44 perpendicular orientation
50 second transformer core lamination by way of example with spacing elements
52 second transformer core lamination
54 third through-hole
56 fourth through-hole
58 first transformer core limb
60 second transformer core limb
62 third transformer core limb
64 first cooling channel
66 first yoke
68 second yoke
70 transformer core by way of example
72 third transformer core lamination
76 sixth opening area
78 seventh opening area
80 first spacing element
82 second spacing element
84 third spacing element
86 fourth spacing element
88 second cooling channel
90 third cooling channel
92 fourth cooling channel
94 fifth cooling channel
96 sixth cooling channel
100 transformer core limb with electric winding
102 fourth transformer core lamination
104 fifth transformer core lamination
106 sixth transformer core lamination
108 first hollow element
110 second hollow element
112 seventh cooling channel
114 eighth cooling channel
116 electric winding in the form of a cylindrical hollow body

What is claimed is:

1. A transformer core for a power transformer, the transformer core comprising:
at least two transformer core laminations arranged in parallel and at least almost congruently adjacent to one another, the transformer core laminations having a similar outline;
at least one through-hole provided in the outline in each case; and
at least one cooling channel arranged between the transformer core laminations,
wherein the transformer core laminations are at least predominantly comprised of an amorphous ferromagnetic material.

2. The transformer core according to claim 1, comprising:
a plurality of cooling channels arranged along the entirety of the outline.

3. The transformer core according to claim 1, wherein the amorphous ferromagnetic material is in the form of a ribbon and is arranged in several adjacent layers running transverse to the outline around the at least one through-hole, such that a thickness of a transformer core lamination results from a width of ribbon material.

4. The transformer core according to claim 1, wherein the outline of each of the at least two transformer core laminations is approximately rectangular, and each of the at least one through-hole is also approximately rectangular such that at least two transformer core limbs and at least two transformer core yokes are formed.

5. The transformer core according to claim 4, wherein the at least two transformer core laminations are configured to be opened and closed, respectively, by layers in at least one limb and/or yoke, such that in an open state a hollow cylindrical body, which is penetrated by the limb, is configured to slide on at least one limb.

6. The transformer core according to claim 1, wherein the at least one cooling channel is formed at least in part by spacing elements separating the transformer core laminations.

7. The transformer core according to claim 1, wherein the at least one cooling channel is formed at least in part by at least one hollow element.

8. The transformer core according to claim 1, wherein the at least one cooling channel is comprised of an electrically insulating material.

9. The transformer core according to claim 1, comprising:
at least one of a common supply connection and a common discharge connection for a cooling medium flowing through the at least one cooling channel.

10. The transformer core according to claim 4, wherein the transformer core is arranged in suspension with an outline oriented perpendicularly.

11. The transformer core according to claim 4, comprising:
at least one electric winding arranged around a winding axis, the at least one electric winding being arranged on a limb of the transformer core,
wherein the winding is penetrated along its winding axis by the limb.

12. A power transformer comprising:
a winding; and
a transformer core according to claim 1.

13. The power transformer according to claim 12, wherein the power transformer is a three-phase transformer comprising three primary and three secondary windings.

14. The transformer core according to claim 2, wherein the amorphous ferromagnetic material is in the form of a ribbon and is arranged in several adjacent layers running transverse to the outline around the at least one through-hole, such that a thickness of a transformer core lamination results from a width of ribbon material.

15. The transformer core according to claim 14, wherein the outline of each of the at least two transformer core laminations is approximately rectangular, and each of the at least one through-hole is also approximately rectangular such that at least two transformer core limbs and at least two transformer core yokes are formed.

16. The transformer core according to claim 15, wherein the at least two transformer core laminations are configured to be opened and closed, respectively, by layers in at least one limb and/or yoke, such that in an open state a hollow cylindrical body, which is penetrated by the limb, is configured to slide on at least one limb.

17. The transformer core according to claim 16, wherein the at least one cooling channel is formed at least in part by spacing elements separating the transformer core laminations.

18. The transformer core according to claim 17, wherein the at least one cooling channel is formed at least in part by at least one hollow element.

19. The transformer core according to claim 17, wherein the at least one cooling channel is comprised of an electrically insulating material.

20. The transformer core according to claim 17, comprising:
at least one of a common supply connection and a common discharge connection for a cooling medium flowing through the at least one cooling channel.

21. The transformer core according to claim 17, wherein the transformer core is arranged in suspension with an outline oriented perpendicularly.

22. The transformer core according to claim 17,
comprising:
at least one electric winding arranged around a winding axis, the at least one electric winding being arranged on a limb of the transformer core,
wherein the winding is penetrated along its winding axis by the limb.

23. A power transformer comprising the at least one electric winding, and a transformer core according to claim 22.

24. The power transformer according to claim 23, wherein the power transformer is a three-phase transformer comprising three primary and three secondary windings.
